(19) United States
(12) Patent Application Publication
(10) Pub. No.: US 2006/0072689 A1
(43) Pub. Date: Apr. 6, 2006

(54) Matched filter and cross correlation method

(75) Inventors: Yun-young Kim, Yongin-si (KR); Sung-hyun Chung, Seongnam-si (KR); Jae-min Ahn, Yongin-si (KR); Min-joong Rim, Seoul (KR); Jae-ho Roh, Seoul (KR); Jae-hyun Koo, Seoul (KR)

Correspondence Address: SUGHRUE MION, PLLC, 2100 PENNSYLVANIA AVENUE, N.W., SUITE 800, WASHINGTON, DC, 20037, US

(73) Assignees: SAMSUNG ELECTRONICS CO., LTD.; ALOGICS CO., LTD.

(21) Appl. No.: 11/236,596

(22) Filed: Sep. 28, 2005

(30) Foreign Application Priority Data
Oct. 1, 2004 (KR) 2004-78288

(51) Int. Cl. H04L 27/06

(52) U.S. Cl. 375/343

(57) ABSTRACT

Disclosed is a matched filter and a method for performing cross correlation thereof. The matched filter includes a demultiplexer for demultiplexing an input sample signal into a predetermined number of signals; and cross correlators that perform a cross correlation of each of the demultiplexed sample signals with a predetermined sequence. Therefore, when the matched filter of the present invention is applied to a UWB system having a high sampling rate, the cross correlation operation can be performed at a high rate simply by using low-rate multipliers.

### CROSS-REFERENCE TO RELATED APPLICATIONS

This application claims priority under 35 U.S.C. § 119 from Korean Patent Application No. 2004-78288, filed on Oct. 1, 2004, the entire content of which is incorporated herein by reference.

### BACKGROUND OF THE INVENTION

1. Field of the Invention

The present invention relates in general to a matched filter and a method for performing cross correlation thereof. More specifically, the present invention relates to a matched filter for performing a cross correlation with a sequence, and a cross correlation method thereof.

2. Description of the Related Art

A multiband Orthogonal Frequency Division Multiplexing (OFDM) system essentially detects a packet by converting an analog input signal to a digital signal, inputting the converted digital signal to a matched filter as a sample signal, then performing cross correlation on the sample signal to output a correlation value. The power consumption and processing rate of the system associated with packet detection relies heavily on the matched filter.

FIG. 1 is a schematic view of a related art matched filter.

Referring to FIG. 1, the matched filter 100 includes a 128-bit shift register 110 and a cross correlator 120. Since the number of bits in the packet sequence for the multiband OFDM system is 128, the 128-bit shift register 110 and the cross correlator 120 composed of 128 multipliers are used.

A sample signal inputted to the matched filter 100 enters the 128-bit shift register 110 and is inputted to each of the 128 multipliers of the cross correlator 120. In those 128 multipliers, a sequence which is composed of tap coefficients aα₀, α₁, . . . , α₁₂₆, α₁₂₇ and 128 sample signals from the shift register 110 are multiplied. That is, a cross correlation is performed on the 128 sample signals from the shift register 110 and the sequence of tap coefficients (α₀, α₁, . . . , α₁₂₆, ₁₂₇). The results of multiplication of the 128 multipliers are added by an adder 130 and the added result is outputted as a correlation value.

However, a common drawback in performing the cross correlation for the sequence (α₀, α₁, . . . , α₁₂₆, α₁₂₇) using the matched filter 100 in FIG. 1 was that as many as 128 multiplications had to take place for a single cross correlation operation. To do so, 128 multipliers were required to carry out the operation, and needless to say, a lot of power was consumed during the course thereof. Thus, a matched filter as shown in FIG. 2 was developed as an alternative.

FIG. 2 is a schematic view of another example of related art matched filters.

The matched filter 200 shown in FIG. 2 includes an 8-bit shift register 210, a first cross correlator 220, and a second cross correlator 230.

A sample signal inputted to the matched filter 200 enters the 8-bit shift register 210 and is inputted to the first cross correlator 220. The eight sample signals inputted to the first cross correlator 220 are outputted to a first multiplication unit 221 composed of eight multipliers. In the first multiplication unit 221 of the first cross correlator 220, multiplications of the sequence B composed of first tap coefficients β₀, β₁, . . . , β₆, β₇ and eight sample signals from the shift register 210 are performed. In other words, the eight sample signals from the shift register 210 are cross correlated with the sequence B (β₀, β₁, . . . , β₆, β₇).

The outputs of the first multiplication unit 221 are added by the first adder 222.

The added result of the first adder 222 entering the second cross correlator 230 is delayed through a delay unit 231 composed of 15 delayers by a certain amount time, respectively, and outputted to a second multiplication unit 232. Here, each delayer ‘D⁻⁸’ delays the output by 8Tₛ, where Tₛ indicates a sampling time. For example, if a signal enters the D⁻⁸ block once, the output is delayed by 8Tₛ. In a similar manner, if a signal enters the D⁻⁸ block n times, the output is delayed by 8Tₛ×n. The second multiplication unit 232 is composed of 16 multipliers.

The added result from the first adder 222 is differentially delayed through the delay unit 231, and then multiplied by the sequence A composed of second tap coefficients α₁₅, α₁₄, . . . , α₁, α₀ at the 16 multipliers of the second multiplication unit 232. In other words , the added result from the first adder 222 is differentially delayed through the delay unit 231, and the 16 delayed output signals from the delay unit 231 are cross correlated with the sequence A (α₀, α₁, . . . , α₁₄, α₁₅).

The results of multiplications of the second multiplication unit 232 are added by the second adder 233, and outputted as a correlation value.

Unlike the matched filter 100 as shown in FIG. 1, the matched filter 200 of FIG. 2 uses 24 multipliers for a single cross correlation operation, and only 24 multiplications take place. Therefore, as far as the frequency of multiplication operation is concerned, the matched filter 200 of FIG. 2 has achieved a considerable success.

In a system using broad bandwidth, however, the problem of a high rate of multiplication operation outweighs the benefit of the reduced frequency of multiplication operation.

For example, an Ultra-WideBand (UWB) system using a 528 MHz bandwidth, that has recently drawn a lot of interest, requires a processing rate as high as 528 MHz. Therefore, the problem with the matched filter 200 as shown in FIG. 2 was that, although it could manage a high-rate multiplication operation somehow, power consumption thereof was very high.

### SUMMARY OF THE INVENTION

An aspect of the present invention provides a matched filter and a method for performing cross correlation, in which input sample signals are cross correlated in parallel and a high-rate cross correlation using low-rate multipliers can be performed on sample signals inputted to a broad bandwidth system.

To achieve the above aspects and/or features, there is provided a matched filter including: a demultiplexer that demultiplexes an input sample signal into a predetermined number of signals; and cross correlators that perform a cross correlation of each of the demultiplexed sample signals with a predetermined sequence.

Preferably, but not necessarily, the matched filter further includes a buffer for temporarily storing the sample signals demultiplexed by a designated number (N) of times where the N is calculated based on the number of tap coefficients; and the cross correlator divides the temporarily stored sample signals into the predetermined number of sample signal groups.

Preferably, but not necessarily, the sample signal groups are sample signals that are sequentially selected from the temporarily stored sample signals according to the number of the tap coefficients of the sequence.

Preferably, but not necessarily, each of the sample signal groups is delayed by one sample signal from the preceding sample signal group being temporarily stored.

Preferably, but not necessarily, the cross correlators are composed of: a first cross correlator for performing a cross correlation on each of the demultiplexed sample signals and on a sequence B based on Multi Band OFDM Alliance (MBOA) UWB specifications, respectively; and a second cross correlator for performing a cross correlation on each result of cross correlations associated with the sequence B and on a sequence A based on MBOA UWB specifications, respectively.

Another aspect of the present invention provides a method for performing cross correlation, which comprises: demultiplexing an input sample signal into a predetermined number of signals; and performing a cross correlation of each of the demultiplexed sample signals with a predetermined sequence.

Preferably, but not necessarily, the method further comprises: temporarily storing the sample signals demultiplexed by a designated number (N) of times where the N is calculated based on the number of tap coefficients; and performing the cross correlation, wherein the temporarily stored sample signals are divided into the predetermined number of sample signal groups.

Preferably, but not necessarily, the cross correlation comprises: performing a cross correlation on each of the demultiplexed sample signals and on a sequence B based on MBOA UWB spec, respectively; and performing a cross correlation on each result of cross correlations associated with the sequence A and on a sequence B based on MBOA UWB spec, respectively.

Therefore, when the matched filter of the present invention is applied to a UWB system having a high sampling rate, the cross correlation operation can be performed at a high rate simply by using low-rate multipliers.

### BRIEF DESCRIPTION OF THE DRAWINGS

The above aspects and features of the present invention will be more apparent by describing certain embodiments of the present invention with reference to the accompanying drawings, in which:

FIG. 1 is a schematic view of a related art matched filter;

FIG. 2 is a schematic view of another example of a related art matched filter;

FIG. 3 is a schematic view of a matched filter according to one embodiment of the present invention;

FIG. 4 schematically illustrates a part of the matched filter as shown in FIG. 3; and

FIG. 5 is a flow chart for explaining a method for performing cross correlation by means of a matched filter according to the present invention.

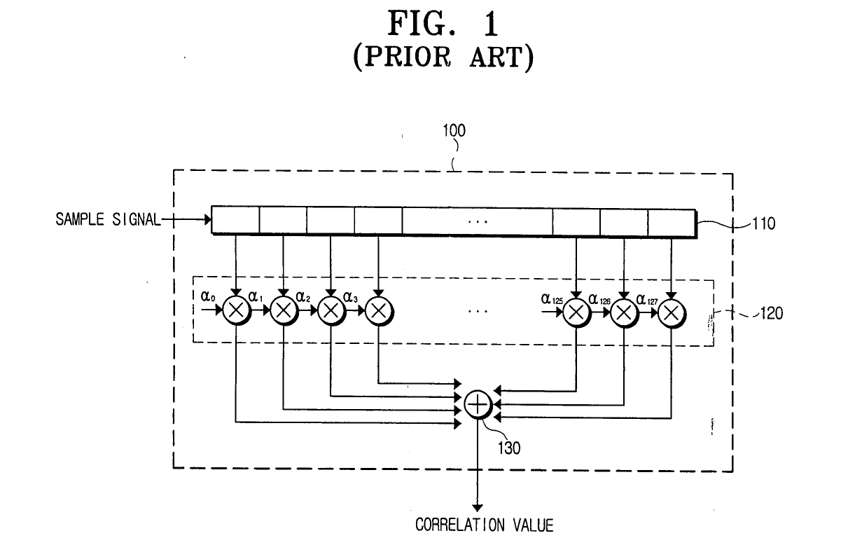

### DETAILED DESCRIPTION OF EXEMPLARY EMBODIMENTS

An exemplary embodiment of the present invention will be described herein below with reference to the accompanying drawings. Well-known functions or constructions are not described in detail since they would obscure the invention in unnecessary detail.

It is also to be understood that the application of a matched filter to a packet detector of a UWB system is described herein for the purpose of describing particular embodiment only, but is not intended to be limiting the claims of the present invention to such embodiment.

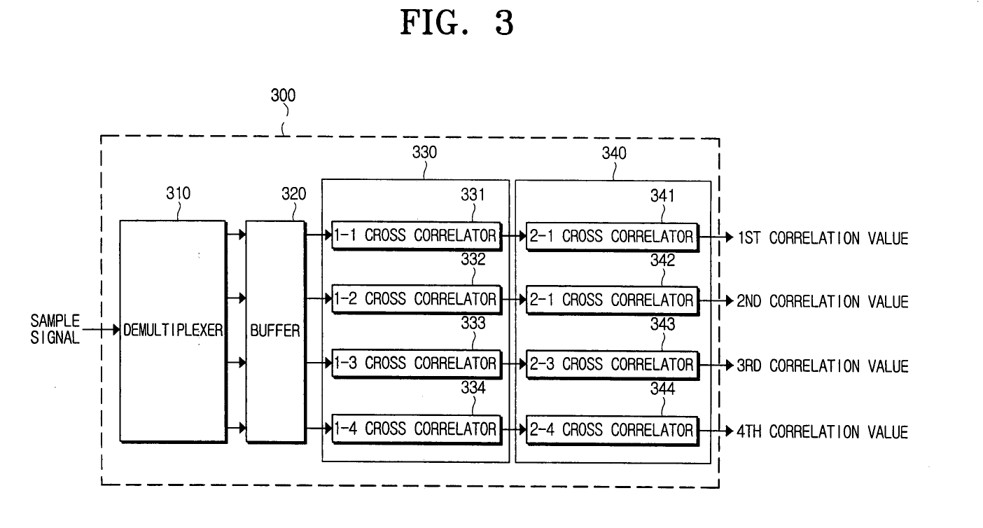

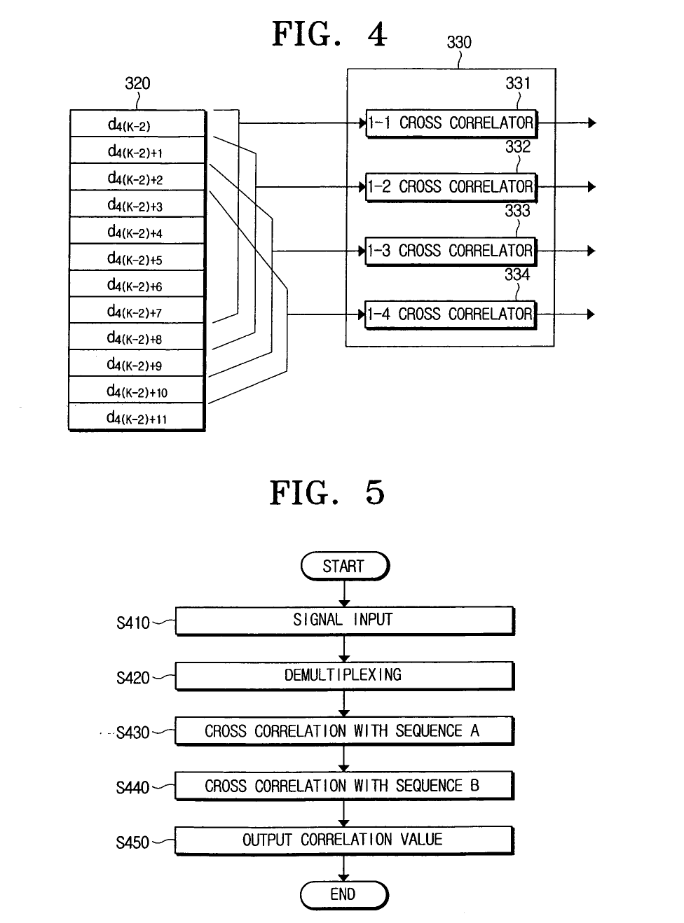

FIG. 3 is a schematic view of a matched filter according to one embodiment of the present invention, and FIG. 4 schematically illustrates a part of the matched filter as shown in FIG. 3, more particularly, a buffer 320 and a first cross correlation unit 330.

In the following description it is assumed that four sample signal groups are cross correlated in parallel. However, the number of sample signals is not limited to four. Instead, an arbitrary number of sample signals are demultiplexed and cross correlated by a corresponding number of cross correlators.

As shown in FIG. 3, a matched filter 300 according to one embodiment of the present invention includes a demultiplexer 310, a buffer 320, a first cross correlation unit 330 and a second cross correlation unit 340.

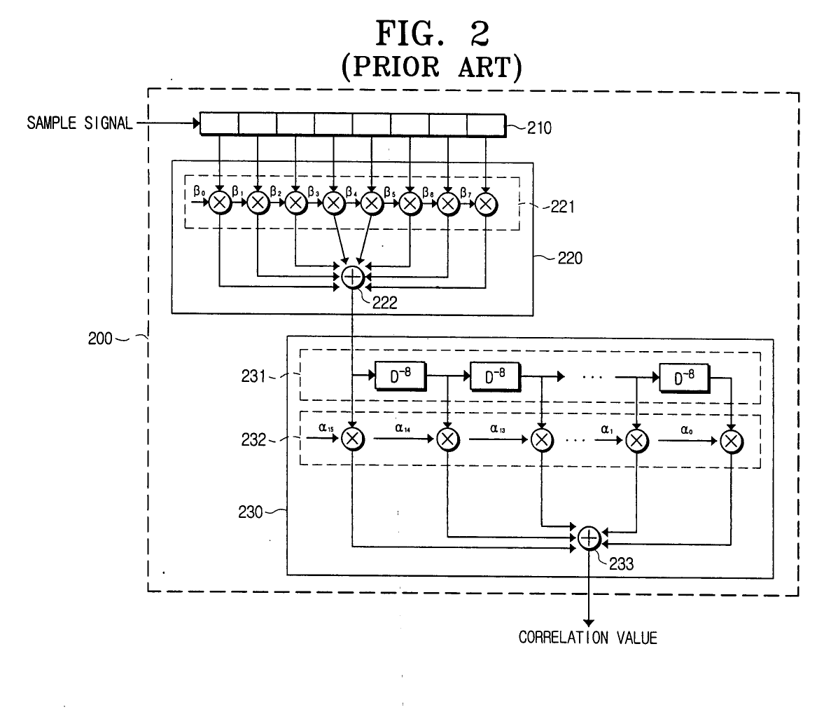

The first cross correlation unit 330 is composed of 1-1 cross correlator 331, 1-2 cross correlator 332, 1-3 cross correlator 333, and 1-4 cross correlator 334 whose function and operation are same as those of the first cross correlator 220 in FIG. 2. Similarly, the second cross correlation unit 340 is composed of 2-1 cross correlator 341, 2-2 cross correlator 342, 2-3 cross correlator 343, and 2-4 cross correlator 344 whose function and operation are same as those of the second cross correlator 230 in FIG. 2. Therefore, the redundant description thereof will not be provided here.

The demultiplexer 310 demultiplexes an input sample signal and outputs four sample signals.

The buffer 320 temporarily stores sample signals (d₄₍ₖ₋₂₎, d₄₍ₖ₋₂₎₊₁, d₄₍ₖ₋₂₎₊₂, d₄₍ₖ₋₂₎₊₃, d₄₍ₖ₋₂₎₊₄, d₄₍ₖ₋₂₎₊₅, d₄₍ₖ₋₂₎₊₆, d₄₍ₖ₋₂₎₊₇, d₄₍ₖ₋₂₎₊₈, d₄₍ₖ₋₂₎₊₉, d₄₍ₖ₋₂₎₊₁₀, d₄₍ₖ₋₂₎₊₁₁). Since 4 sample signals are outputted from the demultiplexer 310 at a time, 12 sample signals are outputted from the demultiplexer 310 over 3 times, i.e., {d₄₍ₖ₋₂₎, d₄₍ₖ₋₂₎₊₁, d₄₍ₖ₋₂₎₊₂, d₄₍ₖ₋₂₎₊₃}, {d₄₍ₖ₋₂₎₊₄, d₄₍ₖ₋₂₎₊₅, d₄₍ₖ₋₂₎₊₆, d₄₍ₖ₋₂₎₊₇}, and {d₄₍ₖ₋₂₎₊₈, d₄₍ₖ₋₂₎₊₉, d₄₍ₖ₋₂₎₊₁₀, d₄₍ₖ₋₂₎₊₁₁,}, and are stored in the buffer 320. The reason for using the expression (k−2) instead of ‘k’ is that sample signals need to be outputted over three times in order to perform a single cross correlation operation.

In addition, a total of 11 sample signals are needed to perform a single cross correlation operation. This explains why the sample signals are outputted three times. More details on this will be provided in reference to FIG. 4.

The sample signals temporarily stored in the buffer 320 are outputted to the first cross correlation unit 330 for a cross correlation with the sequence B (β₀, β₁, . . . , β₆, β₇). Details on the sequence B and the sequence A (α₀, α₁, . . . , α₁₄, α₁₅) will not be provided throughout the specification, except that they are based on the Multi Band OFDM Alliance (MBOA) UWB specifications.

Each cross correlator 331, 332, 333 and 334 of the first cross correlation unit 330 uses eight sample signals for performing a cross correlation. As can be seen in FIG. 4, the first sample signal group (d₄₍ₖ₋₂₎, d₄₍ₖ₋₂₎₊₁, d₄₍ₖ₋₂₎₊₂, d₄₍ₖ₋₂₎₊₃, d₄₍ₖ₋₂₎₊₄, d₄₍ₖ₋₂₎₊₅, d₄₍ₖ₋₂₎₊₆, d₄₍ₖ₋₂₎₊₇) is outputted to the 1-1 cross correlator 331, the second sample signal group (d₄₍ₖ₋₂₎₊₁, d₄₍ₖ₋₂₎₊₂, d₄₍ₖ₋₂₎₊₃, d₄₍ₖ₋₂₎₊₄, d₄₍ₖ₋₂₎₊₅, d₄₍ₖ₋₂₎₊₆, d₄₍ₖ₋₂₎₊₇, d₄₍ₖ₋₂₎₊₈) is outputted to the 1-2 cross correlator 332, the third sample signal group (d₄₍ₖ₋₂₎₊₂, d₄₍ₖ₋₂₎₊₃, d₄₍ₖ₋₂₎₊₄, d₄₍ₖ₋₂₎₊₅, d₄₍ₖ₋₂₎₊₆, d₄₍ₖ₋₂₎₊₇, d₄₍ₖ₋₂₎₊₈, d₄₍ₖ₋₂₎₊₉) is outputted to the 1-3 cross correlator 333, and the fourth sample signal group (d₄₍ₖ₋₂₎₊₃, d₄₍ₖ₋₂₎₊₄, d₄₍ₖ₋₂₎₊₅, d₄₍ₖ₋₂₎₊₆, d₄₍ₖ₋₂₎₊₇, d₄₍ₖ₋₂₎₊₈, d₄₍ₖ₋₂₎₊₉, d₄₍ₖ₋₂₎₊₁₀) is outputted to the 1-4 cross correlator 334. That is, each sample signal group is composed of sample signals delayed by one sample signal. Therefore, 11 sample signals are required in order for the first cross correlation unit 330 to be driven once.

The sample signal groups inputted to the cross correlation unit 330 are cross correlated with the sequence B, and the results of such cross correlations, which are, c₄ₖ, c₄ₖ₊₁, c₄ₖ₊₂ and c₄ₖ₊₃, are outputted to the second cross correlation unit 340.

The following equations 1, 2, 3 and 4 show how a sample signal dₙ is cross correlated with the sequence B to generate cₙ.
c₄ₖ=Σd₄₍ₖ₋₂₎₊ₘ×βₘ [Equation 1]

wherein, m is an integer selected from 0 to 7, and corresponds to eight multipliers of the 1-1 cross correlator 331.
c₄ₖ₊₁=Σd₄₍ₖ₋₂₎₊ₘ₊₁×βₘ [Equation 2]

wherein, m is an integer selected from 0 to 7, and corresponds to eight multipliers of the 1-2 cross correlator 332.
c₄ₖ₊₂=Σd₄₍ₖ₋₂₎₊ₘ₊₂×βₘ [Equation 3]

wherein, m is an integer selected from 0 to 7, and corresponds to eight multipliers of the 1-3 cross correlator 333.
c₄ₖ₊₃=Σd₄₍ₖ₋₂₎₊ₘ₊₃×βₘ [Equation 4]

wherein, m is an integer selected from 0 to 7, and corresponds to eight multipliers of the 1-4 cross correlator 334.

In the 2-1 cross correlator 341 of the second cross correlation unit 340, the input value c₄ₖ and delayed values of c₄ₖ are cross correlated with the sequence A, and a first correlation value is generated in result.

In the 2-2 cross correlator 342 of the second cross correlation unit 340, the input value c₄ₖ₊₁ and delayed values of c₄ₖ₊₁ are cross correlated with the sequence A, and a second correlation value is generated in result.

In the 2-3 cross correlator 343 of the second cross correlation unit 340, the input value c₄ₖ₊₂ and delayed values of c₄ₖ₊₂ are cross correlated with the sequence A, and a third correlation value is generated in result.

In the 2-4 cross correlator 344 of the second cross correlation unit 340, the input value c₄ₖ₊₃ and delayed values of c₄ₖ₊₃ are cross correlated with the sequence A, and a fourth correlation value is generated in result.

That is, according to the matched filter 300 of the present invention, 11 input sample signals are buffered and four correlation values are generated simultaneously.

Therefore, if the matched filter 300 of the present invention is applied to a broad bandwidth system, the cross correlation operation can be performed simply by using low-rate multipliers.

FIG. 5 is a flow chart for explaining a cross correlation performing method by means of the matched filter according to the present invention.

Referring to FIG. 3 to FIG. 5, if a sample signal is inputted to the matched filter 300 (S410), the demultiplexer 310 of the matched filter 300 demultiplexes the sample signal. In result, four sample signal groups are outputted (S420).

Each sample signal group is inputted to 1-1 cross correlator 331, 1-2 cross correlator 332, 1-3 cross correlator 333, and 1-4 cross correlator 334, respectively, and is cross correlated with the sequence B, As a result of cross correlations, c₄ₖ, c₄ₖ₊₁, c₄ₖ₊₂, and c₄ₖ₊₃ are generated (S430).

Subsequenty, the abovegenerated values c₄ₖ, c₄ₖ₊₁, c₄ₖ₊₂, and c₄ₖ₊₃ are inputted to 2-1 cross correlator 341, 2-2 cross correlator 342, 2-3 cross correlator 343, and 2-4 cross correlator 344, respectively, and are cross correlated with the sequence A (S440).

Lastly, four correlation values are outputted from 2-1 cross correlator 341, 2-2 cross correlator 342, 2-3 cross correlator 343, and 2-4 cross correlator 344 (S450).

As described above, the matched filter and its cross correlation method of the present invention enables a system using a high sampling rate, a UWB system for example, to perform the cross correlation operation at a very high rate employing only low-rate multipliers. In result, by reducing a clock rate associated with the cross correlation in the system using a high sampling rate, it becomes possible to reduce power consumption and improve the processing rate.

The foregoing embodiment and advantages are merely exemplary and are not to be construed as limiting the present invention. The present teaching can be readily applied to other types of apparatus. Also, the description of the embodiment of the present invention is intended to be illustrative, and not to limit the scope of the claims, and many alternatives, modifications, and variations will be apparent to those skilled in the art.

What is claimed is:

1. A matched filter comprising:
a demultiplexer that demultiplexes an input sample signal into a predetermined number of signals; and
cross correlators that perform a cross correlation of each of the demultiplexed sample signals with a predetermined sequence.

2. The matched filter according to claim 1, further comprising:
a buffer for temporarily storing a plurality of sample signals demultiplexed by a designated number (N) of times where the N is calculated based on the number of tap coefficients; and
at least one cross correlator that divides the temporarily stored sample signals into the predetermined number of sample signal groups.

3. The matched filter according to claim 3, wherein the sample signal groups are sample signals that are sequentially selected from the temporarily stored sample signals according to the number of the tap coefficients of the sequence.

4. The matched filter according to claim 3, wherein each of the sample signal groups of the temporarily stored sample signals is delayed by one sample signal from the preceding sample signal group.

5. The matched filter according to claim 1, wherein the cross correlators comprise:
a first cross correlator that performs a cross correlation on each of the demultiplexed sample signals and on a sequence A based on MBOA (Multi Band OFDM Alliance (MBOA) UWB spec, respectively; and
a second cross correlator that performs a cross correlation on each result of cross correlations associated with the sequence B and on a sequence A based on MBOA UWB specifications, respectively.

6. A method for performing cross correlation comprising:
demultiplexing an input sample signal into a predetermined number of signals; and
performing a cross correlation of each of the demultiplexed sample signals with a predetermined sequence.

7. The method according to claim 6, further comprising:
temporarily storing the sample signals that are demultiplexed by a designated number (N) of times where the N is calculated based on the number of tap coefficients; and
performing the cross correlation, wherein the temporarily stored sample signals are divided into the predetermined number of sample signal groups.

8. The method according to claim 7, wherein the sample signal groups are sample signals that are sequentially selected from the temporarily stored sample signals according to the number of the tap coefficients of the sequence.

9. The method according to claim 8, wherein each of the sample signal groups of the temporarily stored sample signals is delayed one sample signal from the preceding sample signal group being temporarily stored.

10. The method according to claim 6, wherein the cross correlation comprises:
performing a cross correlation on each of the demultiplexed sample signals and on a sequence B based on MBOA UWB specifications, respectively; and
performing a cross correlation on each result of cross correlations associated with the sequence B and on a sequence A based on MBOA UWB specifications, respectively.
